(19) United States
(12) Patent Application Publication
(10) Pub. No.: US 2006/0100553 A1
(43) Pub. Date: May 11, 2006

(54) Heart valve decalcification method and apparatus

(76) Inventor: David W. Lodin, Maple Grove, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/257,531

(22) Filed: Oct. 25, 2005

Related U.S. Application Data
(60) Provisional application No. 60/621,627, filed on Oct. 25, 2004.

(51) Int. Cl. A61H 1/00

(52) U.S. Cl. 601/2; 606/200; 606/34

(57) ABSTRACT

A method and apparatus for removing plaque deposits from an intact in situ heart valve. The interventional system includes an energy delivery disruption catheter and both a passive and active system to remove debris.

### CROSS REFERENCE TO RELATED APPLICATIONS

The present application claims the benefit of U.S. Provisional Application 60/621,627 filed Oct. 25, 2004, which is incorporated by reference herein in its entirety.

### BACKGROUND OF THE INVENTION

Heart disease can result in the deposit of calcium plaques on the surface of the leaflets of the heart valve. These deposits compromise valve function. In general the deposits reduce the orifice area of the valve, which reduces the pumping efficiency of the heart. The deposits also initiate a cascade of injury that can result in congestive heart failure. It is widely accepted that patients with heavily calcified valves should have these valves removed and replaced with prosthetic valves. The replacement of heart valves requires open heart surgery. This is a major intervention not available to all patients.

There have been some efforts to remove calcium deposits in situ. For example, Nita et al U.S. Pat. No. 6,454,737 uses ultrasound to remove plaque from the interior of a blood vessel.

In Toysaya, U.S. Patent Application 2004/0230117 A1, a device using ultrasonic energy to remove deposits from an artificial valve is shown. Eggers in his U.S. Pat. No. 6,047,700, shows the use of high frequency electrical energy to remove plaque from a natural heart valve.

In spite of these advances there is a continuing need to provide therapies that are more widely applicable to valve disease.

### SUMMARY OF THE INVENTION

In contrast to the prior art the system of the present invention includes an energy delivery “disruption” catheter that interacts with and disrupts calcium plaques, along with an extraction system that may include an active aspiration system associated with an extraction catheter that collects and removes the debris created by the intervention. Also present in the system is a filter device on a filtration catheter that traps errant particulate and other debris as a form of passive extraction.

In a preferred operation, the catheter based interventional system is moved to the location of the aortic valve through the descending aorta. First a delivery catheter deploys the passive filtration catheter. This catheter serves several functions and prevent debris from leaving the aorta and entering carotid or other arterial braches. Next an integrated or independent active aspiration extraction catheter is moved toward the valve surface. This extraction catheter recovers debris from the intervention at a site close to the therapy delivery site. A disruption catheter is placed very close to the valve surface and it delivers energy to the valve surface that is used to disrupt the calcified plaque deposits from valves.

The various elements of the system are described in more detail later but the overall architecture of the system involves both a method and a suite of devices. In general it is desired to have the various catheter elements concentric and deployed “over” each other. In this fashion an outer filter trap catheter adapted for femoral access is moved to the aortic valve. This first catheter has within it a deployable filter that emerges from the catheter to cover the aortic root and serves to trap or otherwise restrain embolic particles from passing out of the heart into the aorta. An inner energy delivery catheter delivers mechanical or ultrasonic energy to the heart valve to disrupt and dislodge the calcified material. This energy deliver device is preferably delivered through an extraction catheter with an aspiration lumen. It is preferred that the extraction catheter be associated with either the energy delivery catheter or the filter trap catheter or both or a separate independent catheter. However in any event the device withdraws the otherwise embolic material from the location of the valve. These embolic materials exit the body though the proximal end of the catheter system. At the conclusion of the therapy the system is removed from the body. In operation the preferred sequence is the initial deployment of the passive filter and then operation of the active aspiration elements when energy is delivered to the plaque.

In contrast to open-heart surgery the system is substantially less invasive and can operate on weaker hearts in certain people expanding the therapeutic benefits of the device.

### BRIEF DESCRIPTION OF THE DRAWINGS

Throughout the drawings like reference numerals indicate identical structure wherein:

FIG. 1 is a schematic diagram of the device; and,

FIG. 2 is a schematic diagram of the heart and the device.

### DETAILED DESCRIPTION OF PREFERRED EMBODIMENTS

Mechanism of Action

Experimental work performed suggests that the preferred mechanism of action for the removal of calcified deposits from a valve surface is a mechanical process. It appears that mechanical contact with valve surface is desirable. It is also likely that cavitations near the distal tip of the energy delivery catheter helps to remove deposits.

This energy is transmitted through the blood. It is expected that removal of blood near the site of plaque removal will reduce hemolysis.

More data needs to taken to fully characterize the operation of the device and the mechanism of action and experimental data suggests that there is an optimum operating frequency for the energy delivery or “disruption” catheter. It is expected that the process will be intermittent. The evidence suggests an optimal effect occurs when the catheter operates in the range between 15 Khz and 30 Khz. In the face of these data the invention may make use of any of the available plaque disruption devices although mechanical methods are preferred. These observations apply to ultrasonic mechanical disruption catheters. However other energy sources are within the scope of the invention including but not limited to low frequency mechanical impact devices as well as optical laser based disruption systems.

At the present time the size of the particulate produced by the intervention are not well characterized. It is expected that large debris will be trapped by the passive filter in the system and that small particulates will be removed by active aspiration near the valve.

Implementation

It is preferred to use the filter/trap catheter for passive debris collection together with the energy delivery catheter in addition to providing active aspiration at or near the site of the valve. The exemplary embodiments in the application show this combination. However, it may also be useful to use the energy delivery catheter alone or with an alternate debris removal system, which combination is contemplated within the scope of the invention.

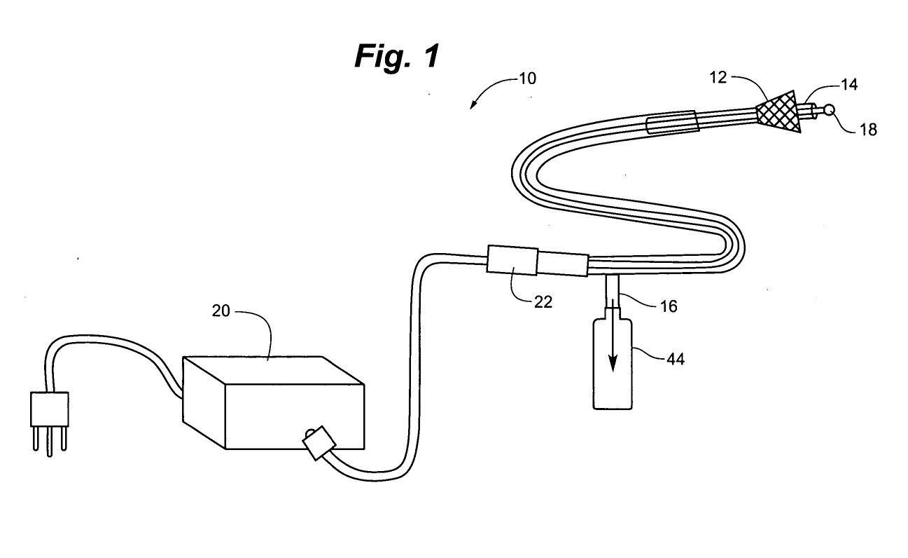

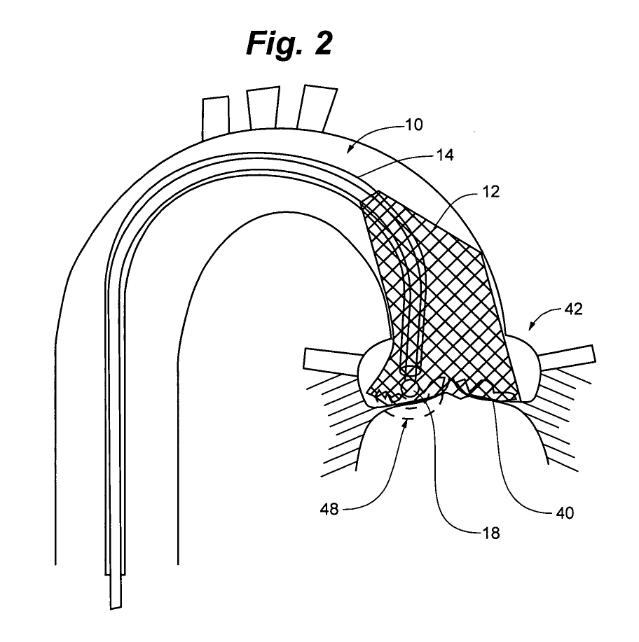

FIG. 1 and FIG. 2 should be considered together. FIG. 1 shows the interventional system 10 including an outer passive extraction catheter 12. An active aspiration extraction catheter 14 is shown inside the passive extraction catheter 12. A drain 16 on the extraction catheter permits removal of debris form the valve treatment site. The innermost catheter is the disruption catheter 18 that supplies energy from a control generator 20 through a coupler 22 to the disruption catheter that may be an ultrasonic catheter.

FIG. 2 shows the heart in partial section with the aortic valve 40 shown at the base of the aortic root 42. The remaining heart anatomy is not shown for clarity. But it should be clear that the blood flow is flowing in through the diseased valve into the aorta from the left ventricle. The heart is not “stopped” during the procedure so the valve 40 is in motion. It may be preferred to operate the ultrasonic energy delivery or disruption catheter 18 in synchrony with the heartbeat cycle.

The system 10 includes an “outer” filter/trap catheter 12 and an inner energy delivery catheter 18. The two catheters may be moved independently of each other and the collapsible filter associated with the passive catheter 12 may be deployed from an outer delivery catheter not shown. It is expected that the filter element will be of conventional design fabricated in a nitinol mesh and it may be pushed out of a delivery catheter tube with an attached push wire (not shown). This filter structure is similar to an aortic filter or aortic stent in terms of design. It is expected that the “weave” of the filter is “open” to allow the output of the heart to flow freely. It is expected that clinically significant particulate will be trapped by the filter mesh. It is generally intended to collect debris that is not caught by the aspiration catheter.

Both catheters 18 and 12 enter the patient remotely through a conventional femoral access. Although the system is subject to refinement the energy delivery or disruption catheter 18 will be coupled to a power generator 20 under the control of the physician. In the figure the energy delivery 18 catheter has already been positioned near the valve. It is expected that other delivery sequences may be used to guide and position the two catheters.

Regulation of aspirated debris will be under control of a physician. In a preferred embodiment an aspiration catheter 14 is delivered to the site of the valve 40 coaxially over the disruption catheter 16. In this embodiment a collection bag 44 is coupled to the drain 16 to collect debris aspirated from the site for the valve. The detail design of the aspiration catheter is well known in this art. In general it is expected that the open lumen of the aspiration catheter will have suction applied to it through a syringe or the like coupled to the collection bag 44. In general the blood flow into the bag 44 will be sufficient to remove debris. It is anticipated that the preferred version of the device will have primary collection of the debris through the active aspiration catheter but alternative or supplemental debris removal may occur through the outer passive extraction catheter 12 as well.

The steps of the method of carrying out the invention is shown in FIG. 2 where the physician first navigates the filter/trap catheter 48 over the energy delivery catheter 46 toward the aortic root and deploys the filter mesh as seen in FIG. 2 to occlude the aorta.

Next the distal tip of the energy delivery disruption catheter 18 is placed at the level of the valve 40 as seen in FIG. 2 and then the physician activates the energy source 20 to disrupt the plaque. Power delivered to the distal tip of the energy delivery catheter 16 disrupts plaque from the valve and is indicated in the figure by the concentric rings 48 representing delivery of energy. Depending on the specific embodiment of the invention this debris released by the disruption catheter is removed or aspirated into a collection vessel coupled to the drain 16.

Thus in summary, the outer guide catheter accesses the aorta near the valve. A filter/trap passive catheter is deployed and this element acts to trap debris created by the intervention. The filter/trap traps and removes debris as it is retracted back into the outer guide catheter. The filter/trap catheter mesh remains deployed while the energy delivery catheter 18 is operating to create debris. The debris is removed through lumens of the aspiration catheter 14.

Alternative embodiments and variations in the detail design of the device are contemplated within the scope of the invention.

What is claimed is:

1. A minimally invasive medical device system for removing plaque deposits or the like from a heart valve comprising:
a debris removal system located in the aorta for preventing debris from leaving a treatment area defined by the removal system location and the aortic root;
a disruption catheter for delivering energy to deposits on the valve at the aortic root.

2. The minimally invasive medical device system of claim 1 wherein said debris removal system includes:
a passive filter trap system located in the aorta for preventing debris from leaving a treatment area defined by the filter location and the aortic root; and,
an active aspiration catheter located proximate the disruption catheter distal end and proximate said valve for removing debris created by said disruption catheter.

3. The minimally invasive medical device system of claim 2 wherein said aspiration catheter includes an open lumen and suction is applied by a fluid ejector.

4. The minimally invasive medical device system of claim 2 wherein said aspiration catheter includes an open lumen and suction is applied by a syringe.

5. The minimally invasive medical device system of claim 2 wherein said disruption catheter delivers acoustic energy to the valve site.

6. The minimally invasive medical device system of claim 2 wherein said disruption catheter delivers mechanical energy to the valve site.

7. A minimally invasive medical device system for removing plaque deposits or the like from a heart valve comprising:
an outer catheter having a proximal end and a distal end and having a passive filter trap device located at its distal end and having a interior lumen extending from said distal end to said proximal end;
a mechanical disruption catheter deployed through said outer catheter movable within said lumen to a position proximate said valve to deliver energy to deposits on said valve whereby debris released from the valve surface is captured by either the passive extraction catheter or the active extraction catheter or both;
an active extraction catheter located proximate a mechanical disruption catheter.
